(19) United States
(12) Patent Application Publication
(10) Pub. No.: US 2008/0140456 A1
(43) Pub. Date: Jun. 12, 2008

(54) EVALUATING SUSCEPTIBILITY TO A CLAIM OCCURRING INFREQUENTLY

(76) Inventors: Gregg W. Glick, San Francisco, CA (US); Brian Mercer, Concord, CA (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 11/852,881

(22) Filed: Sep. 10, 2007

Related U.S. Application Data
(60) Provisional application No. 60/843,602, filed on Sep. 11, 2006.

(51) Int. Cl. G06Q 40/00

(52) U.S. Cl. 705/4

(57) ABSTRACT

Methods and systems are provided for producing a report for an insurable entity providing an evaluation of the insurable entity's susceptibility to an insurable claim of a kind occurring infrequently. Methods and systems are provided for producing a database for producing a report to an insurable entity providing an evaluation of the insurable entity's susceptibility to an insurable claim of a kind occurring infrequently. Methods and systems are provided for producing a report for an insurable entity comparing risk evaluation data for a predetermined type of insurable claim with data representing risk evaluations for the same predetermined type of insurable claim for other entities and parameters of insurance policies of such other entities covering such predetermined type of insurable claim.

This application claims the benefit of U.S. provisional patent application No. 60/843,602 filed Sep. 11, 2006, in the names of Gregg W. Glick and Brian Mercer.

Methods and systems for evaluating an entity's susceptibility to a claim occurring infrequently, and methods and systems for producing and/or updating a database useful for conducting such evaluations, are disclosed.

### BACKGROUND

One of the significant problems facing business entities is to deal with the threat of securities class action lawsuits against its officers and directors. It is common practice to procure directors and officers liability insurance (D&O insurance) to help defray the costs of defending and settling such claims. However, the premiums for such insurance are substantial and it is thus necessary to weigh such premium costs against the extent of insurance coverage to be obtained, particularly the liability limits and retentions of the insurance policy, based on the likelihood of such a lawsuit. However, it is difficult to assess the susceptibility of a business entity to claims that occur infrequently.

In the absence of reliable means to predict potential liability in these cases, many business entities have set such liability limits and retentions of the insurance they purchase based upon those carried by their peers. However, it is dangerous to adopt the liability limits of one's perceived peers, because they may be collectively mistaken. Further and perhaps more significantly, one business is not likely to conduct its affairs just as its peers do, so that risk factors that vary in dependence on such conduct may well indicate that it would be prudent for each business entity to select different parameters for its D&O liability insurance than those of its peers.

Without a reliable process for assessing the susceptibility of a business to a loss due to an investor lawsuit, selecting D&O liability insurance limits and retentions becomes like a game of darts played while blindfolded: a misguided decision can result in substantial financial “pain”, either due to underinsurance or the payment of excessive premiums.

A more reliable basis for making such decisions would be beneficial for business entities and those who manage them.

### DISCLOSURE

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of corresponding information in a different physical form or forms.

The term “presentation data” shall mean data to be presented to a user in any perceptible form, including but not limited to, visual form. Examples of presentation data include data displayed on a visual presentation device, such as a monitor, and data printed on paper.

The term “database” as used herein means an organized body of related data, regardless of the manner in which the data or the organized body thereof is represented. For example, the organized body of related data may be in the form of a table, a map, a grid, a packet, a datagram, a file, an e-mail, a message, a document, a list or in any other form.

The term “network” as used herein includes both networks and internetworks of all kinds, including the Internet, and is not limited to any particular network or internetwork.

The terms “first,” “second,” “primary,” and “secondary” are used herein to distinguish one element, set, data, object, step, process, function, action or thing from another, and are not used to designate relative position, arrangement in time or relative importance, unless otherwise stated explicitly.

The terms “coupled”, “coupled to”, and “coupled with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communications relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

The terms “communicate” and “communicating” as used herein include both conveying data from a source to a destination, and delivering data to a communications medium, system, channel, network, device, wire, cable, fiber, circuit, and/or link to be conveyed to a destination. The term “communications” as used herein includes one or more of a communications medium, system, channel, network, device, wire, cable, fiber, circuit and link.

The term “processor” as used herein means processing devices, apparatus, programs, circuits, components, systems and subsystems, whether implemented in hardware, software or both, and whether or not programmable. The term “processor” as used herein includes, but is not limited to one or more computers, hardwired circuits, signal modifying devices and systems, devices and machines for controlling systems, central processing units, programmable devices and systems, field programmable gate arrays, application specific integrated circuits, systems on a chip, systems comprised of discrete elements and/or circuits, state machines, virtual machines, data processors, processing facilities and combinations of any of the foregoing.

The terms “storage” and “data storage” as used herein mean data storage devices, apparatus, programs, circuits, components, systems, subsystems and storage media serving to retain data, whether on a temporary or permanent basis, and to provide such retained data.

The term “insurable claim” as used herein means claims for damages or other monetary relief of a kind that can be insured against, and includes both lawsuits and other legal proceedings, as well as asserted claims for monetary relief and potential claims for monetary relief.

A method of producing a report for an insurable entity providing an evaluation of the insurable entity's susceptibility to an insurable claim of a kind occurring infrequently comprises providing a plurality of numerical risk characterization data, each of the plurality of numerical risk characterization data corresponding to a respective one of a plurality of risk parameters relating to the insurable entity that is correlated to a susceptibility of the insurable entity to an insurable claim of a kind occurring infrequently; producing numerical claim susceptibility risk value data for the insurable entity based on the plurality of numerical risk characterization data; and providing presentation data to a user comprising a comparison of the numerical claim susceptibility risk value data of the insurable entity to numerical claim susceptibility risk value data of a plurality of other insurable entities.

A system for producing a report to an insurable entity providing an evaluation of the insurable entity's susceptibility to an insurable claim of a kind occurring infrequently comprises a data providing device operative to provide a plurality of numerical risk characterization data, each of the plurality of numerical risk characterization data corresponding to a respective one of a plurality of risk parameters relating to the insurable entity that is correlated to a susceptibility of the insurable entity to an insurable claim of a kind occurring infrequently; a processor coupled with the data providing device to receive the numerical risk characterization data and operative to produce numerical claim susceptibility risk value data for the insurable entity based on the plurality of numerical risk characterization data; and a presentation device coupled with the processor to receive the numerical claim susceptibility risk value data and operative to provide presentation data to a user comprising a comparison of the numerical claim susceptibility risk value data of the insurable entity to numerical claim susceptibility risk value data of a plurality of other insurable entities.

In certain embodiments of such method and system, the numerical claim risk susceptibility value data is produced by applying a weighting factor to each of the plurality of numerical risk characterization data to produce a plurality of weighted numerical risk characterization data; and combining the plurality of weighted numerical risk characterization data to produce the numerical claim susceptibility value data for the insurable entity.

A method of producing a database for producing a report to an insurable entity providing an evaluation of the insurable entity's susceptibility to an insurable claim of a kind occurring infrequently, comprises providing a system comprising a processor, a data storage, and a data providing device; receiving or accessing risk correlatable data for a plurality of entities in the system using the data providing device, the risk correlatable data comprising a plurality of entity descriptors for each of the entities for each of a plurality of risk correlatable descriptor categories; receiving or accessing claims data for the plurality of entities in the system using the data providing device, the claims data indicating for each of the entities whether it has experienced an insurable claim of a kind occurring infrequently; storing the risk correlatable data and the claims data in the data storage; correlating the risk correlatable data and the claims data using the processor to produce weighting factor data for each of the risk correlatable descriptor categories; and producing the database by storing the weighting factor data and associated risk correlatable descriptor category identification data in the data storage.

A system for producing a database for producing a report to an insurable entity providing an evaluation of the insurable entity's susceptibility to an insurable claim of a kind occurring infrequently, comprises a data providing device, a processor coupled with the data providing device, and a data storage coupled with the processor; the processor being operative to receive risk correlatable data for a plurality of entities to the system from the data providing device, the risk correlatable data comprising a plurality of entity descriptors for each of the entities for each of a plurality of risk correlatable descriptor categories, as well as claims data from the data providing device for the plurality of entities, the claims data indicating for each of the entities whether it has experienced an insurable claim of a kind occurring infrequently; the processor being operative to store the risk correlatable data and the claims data in the data storage, to correlate the risk correlatable data and the claims data using the processor to produce weighting data for each of the risk correlatable descriptor categories, and produce the database by storing the weighting data and associated risk correlatable descriptor category identification data in the data storage.

A method of producing a report for an insurable entity comparing risk evaluation data for a predetermined type of insurable claim with data representing risk evaluations for the same predetermined type of insurable claim for other entities and parameters of insurance policies of such other entities covering such predetermined type of insurable claim, comprises producing risk evaluation data for an insurable entity comprising a value representing a measure of the insurable entity's risk for a predetermined type of insurable claim, providing a plurality of risk evaluation data for a plurality of other entities comprising values representing measures of such other entities' risks for such predetermined type of insurable claim, providing insurance data comprising parameters of insurance policies of such other entities covering such predetermined type of insurable claim, comparing the risk evaluation data of the insurable entity with the plurality of risk evaluation data for the plurality of other entities to produce comparison data, and producing presentation data comprising at least one insurance policy parameter for such predetermined type of insurable claim based on the comparison data and the parameters of insurance policies of such other entities.

A system for producing a report for an insurable entity comparing risk evaluation data for a predetermined type of insurable claim with data representing risk evaluations for the same predetermined type of insurable claim for other entities and parameters of insurance policies of such other entities covering such predetermined type of insurable claim, comprises a data providing device, a processor coupled with the data providing device, and a data storage coupled with the processor; the processor being operative to produce risk evaluation data for an insurable entity comprising a value representing a measure of the insurable entity's risk for a predetermined type of insurable claim, the processor being operative to receive from the data providing device a plurality of risk evaluation data for a plurality of other entities comprising values representing measures of such other entities' risks for such predetermined type of insurable claim and insurance data comprising parameters of insurance policies of such other entities covering such predetermined type of insurable claim, the processor being operative to compare the risk evaluation data of the insurable entity with the plurality of risk evaluation data for the plurality of other entities to produce comparison data, and to control the presentation device to produce presentation data comprising at least one insurance policy parameter for such predetermined type of insurable claim based on the comparison data and the parameters of insurance policies of such other entities.

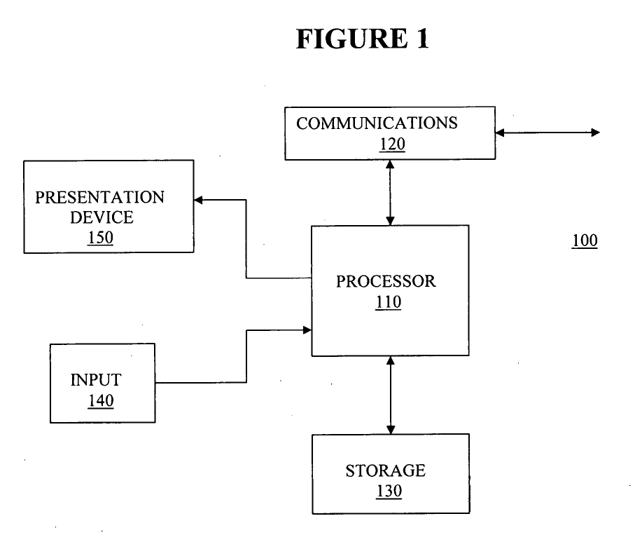

FIG. 1 is a block diagram of a system for producing reports concerning an insurable entity's susceptibility to a claim and for producing and/or updating a database for producing such reports;

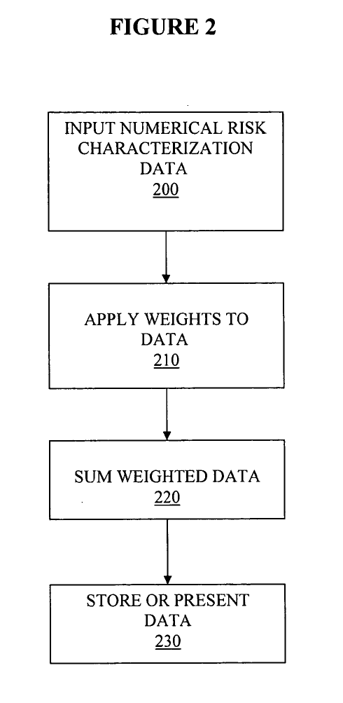

FIG. 2 is a diagram illustrating processes carried out by the system of FIG. 1 in producing such reports;

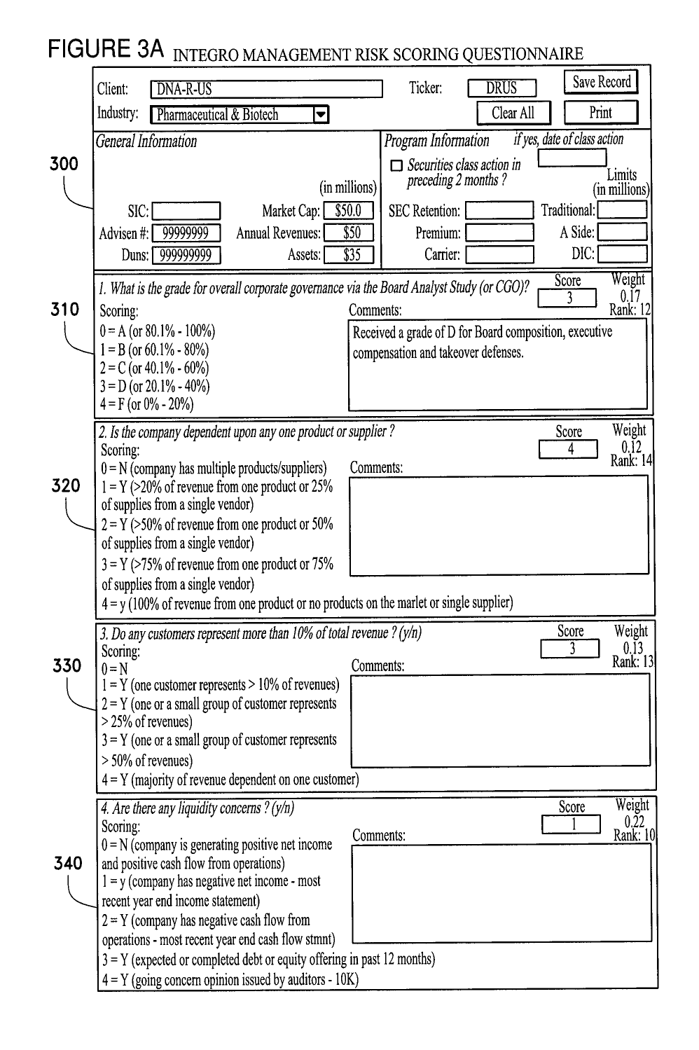

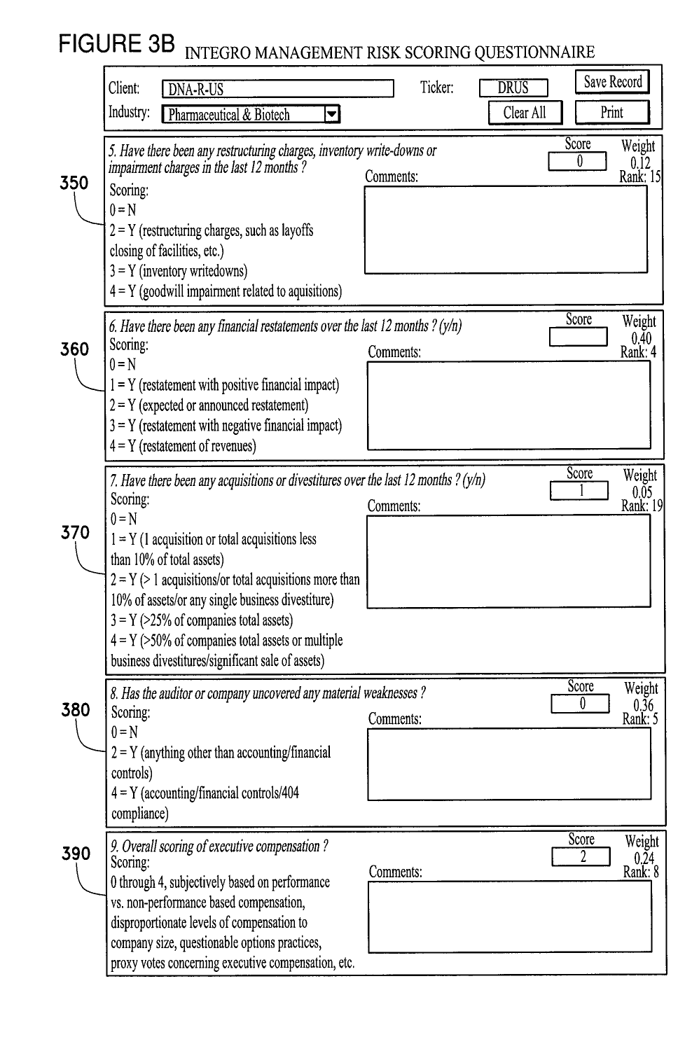

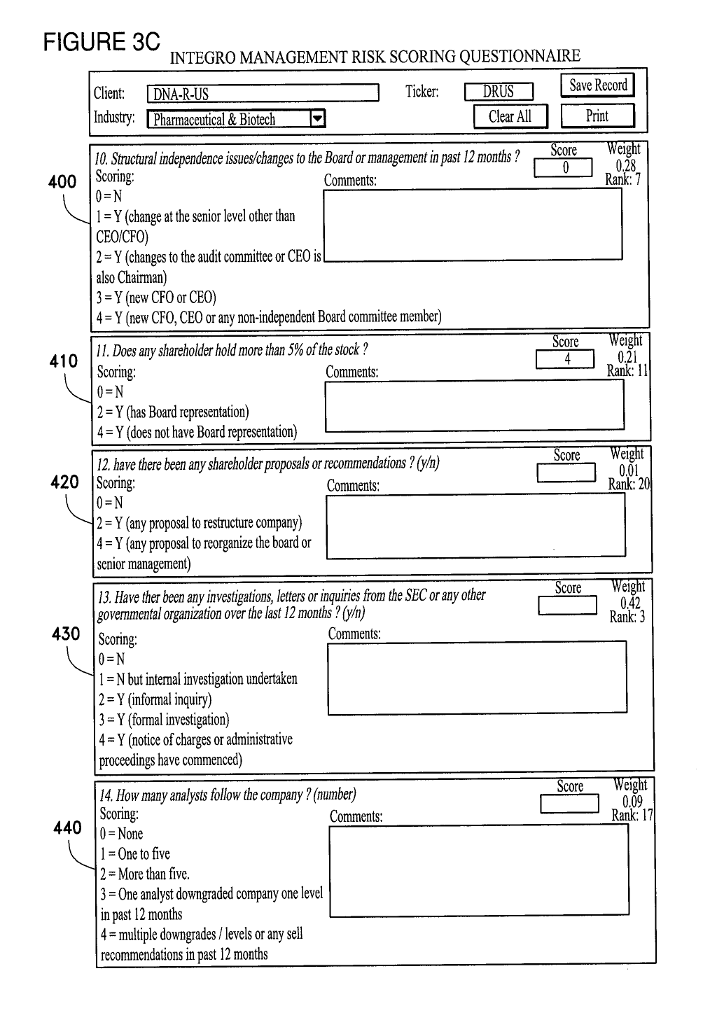

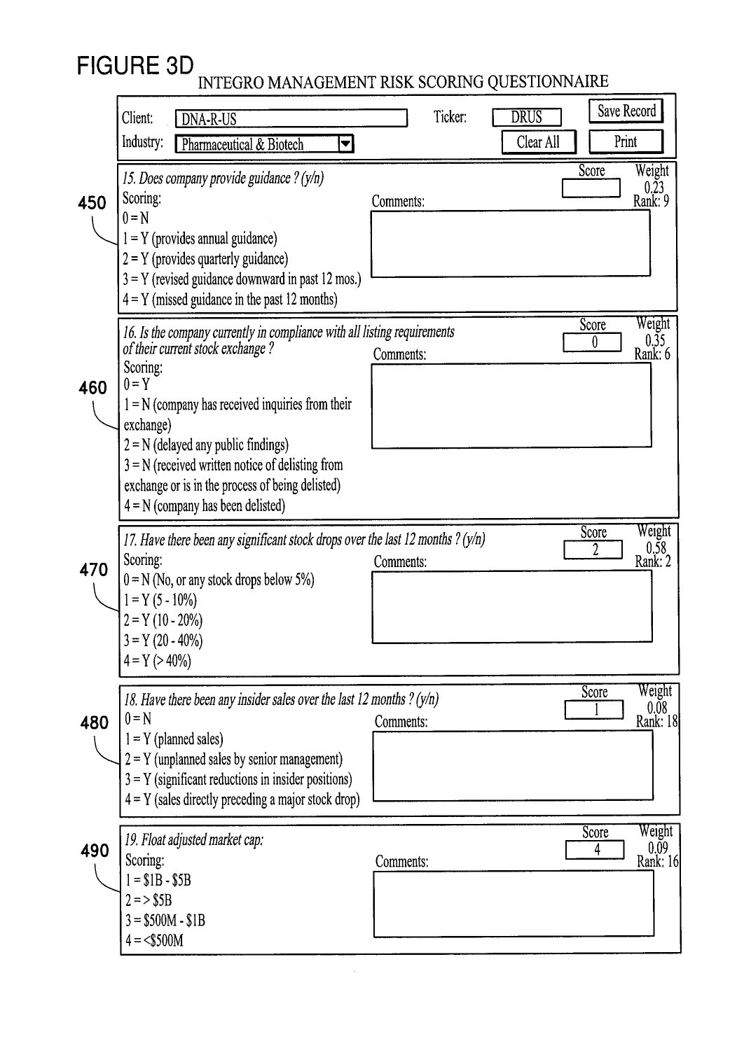

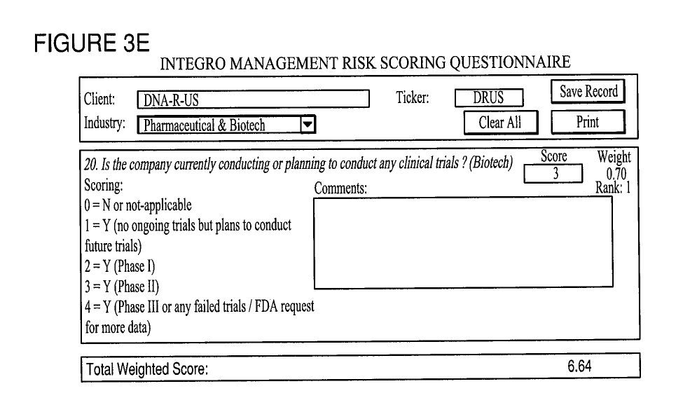

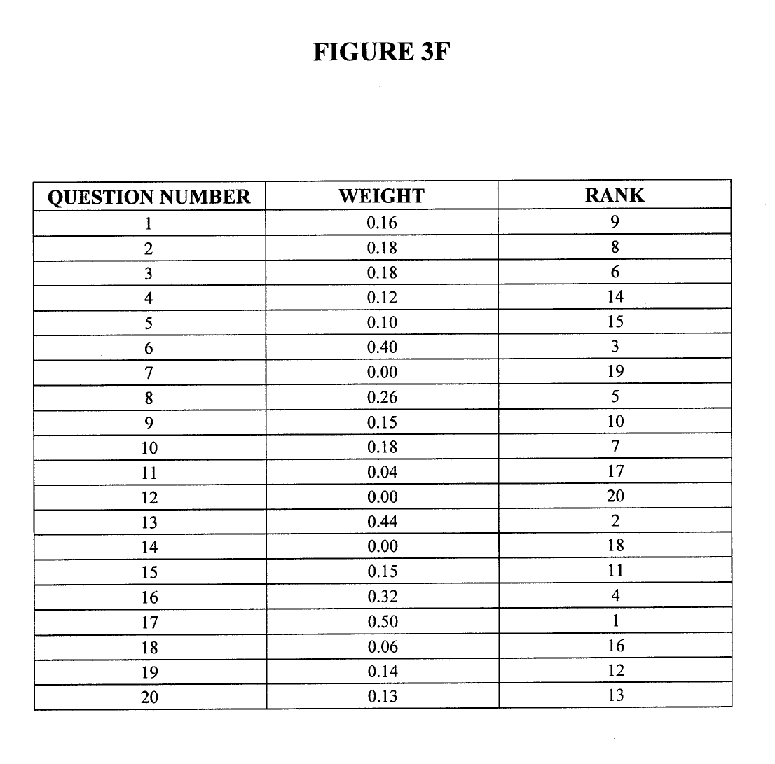

FIGS. 3A through 3E illustrate a data entry form for entering data into the system of FIG. 1;

FIG. 3F is a table representing a further embodiment of a system similar to that of FIGS. 1 through 3E for producing reports concerning an insurable entity's susceptibility to a claim;

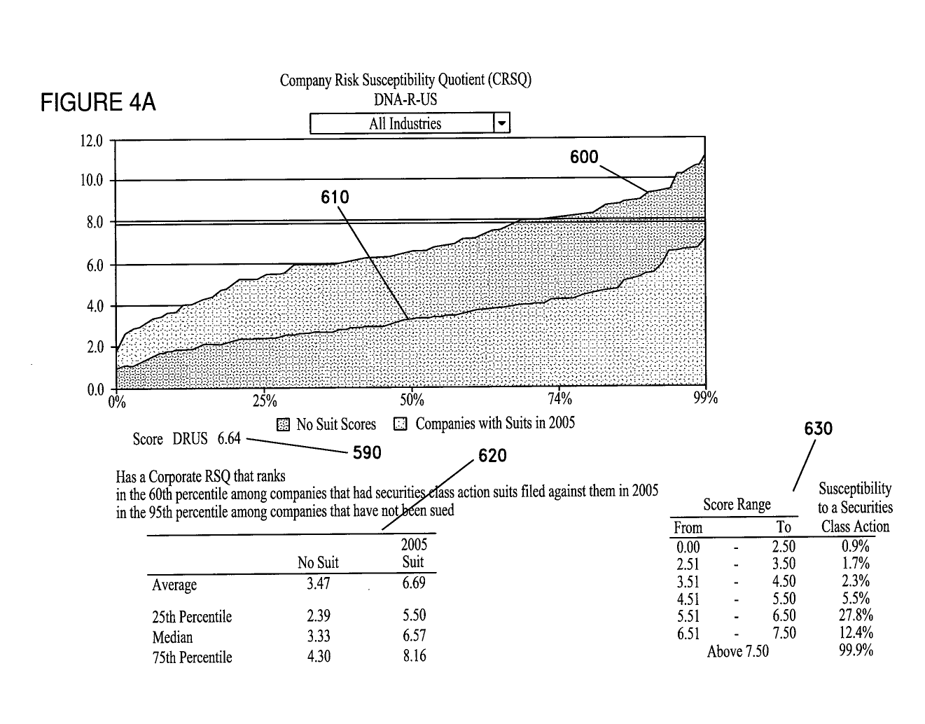

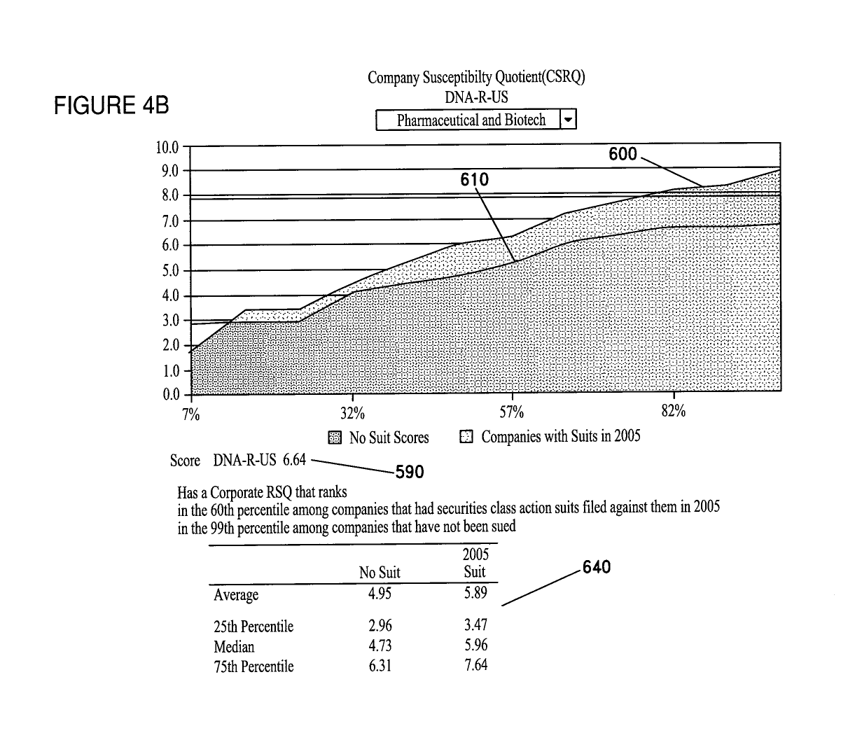

FIG. 4A illustrates a first form of a report produced by the system such as that of FIGS. 1 through 3E or of FIG. 3F;

FIG. 4B illustrates a second form of a report produced by the system such as that of FIGS. 1 through 3E or of FIG. 3F;

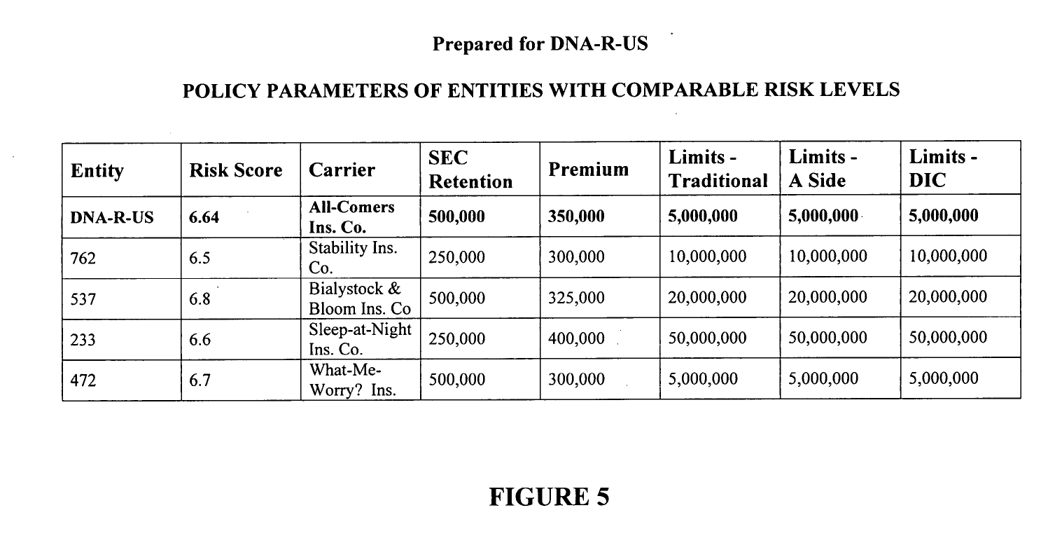

FIG. 5 illustrates a further form of a report produced by a system such as that of FIGS. 1 through 3E or of FIG. 3F;

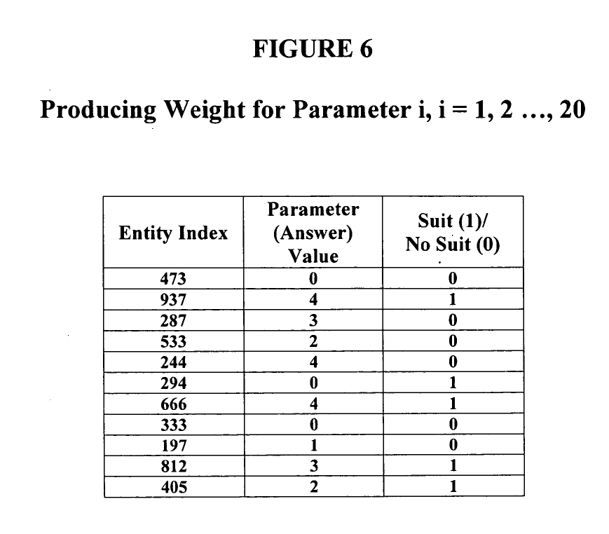

FIG. 6 illustrates a portion of a spreadsheet used by a system such as that of FIGS. 1 through 3E or of FIG. 3F to produce weight data; and

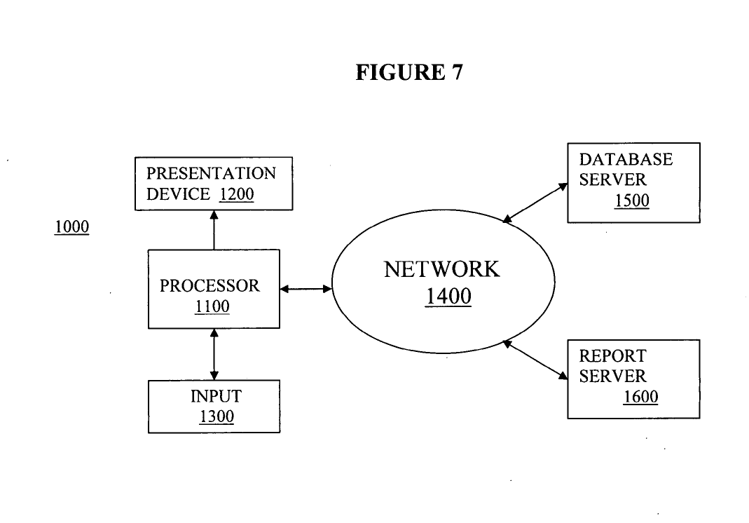

FIG. 7 illustrates further embodiments of systems for producing reports concerning an insurable entity's susceptibility to a claim and for producing and/or updating a database for producing such reports.

With reference to FIG. 1, a processing system 100 comprises a processor 110, communications 120 coupled with the processor 110, storage 130 coupled with the processor, an input device 140 coupled with the processor 110 and a presentation device 150 coupled with the processor 110. Communications 120 serves to communicate data to and from other devices, systems and/or networks from system 100, under the control of processor 110. Storage 130 serves to store and read data under the control of processor 110. Input 140 comprises one or more devices that afford a user the ability to introduce data to the system 100, such as by means of a keypad, keyboard, disk drive, touch screen, light pen, microphone, handwriting interface or the like. Presentation device 150 serves to provide presentation data to a user and comprises one or more devices, such as a monitor, visual display, printer, speaker, headphones or the like.

In certain embodiments, the system of FIG. 1 is programmed or otherwise configured to produce a report for an insurable entity providing an evaluation of the insurable entity's susceptibility to an insurable claim, such as a claim by way of a shareholders' class action, asserting liability of the insurable entity's directors and/or officers. Such types of claims typically are insured against by means of Directors' and Officers' Liability Insurance (D&O insurance).

In such embodiments, and with reference to the flow chart of FIG. 2, a plurality of numerical risk characterization data are supplied to the system 100 via input 140, communications 120 or storage 130, as indicated at 200 in FIG. 2. Such numerical risk characterization data quantify various characteristics of the insurable entity or conditions affecting the insurable entity that have been correlated to its susceptibility to an insurable claim coved by D&O insurance. For this purpose, in certain ones of the embodiments, processor 110 retrieves a data entry form from storage 130 which it controls the presentation device to present to a user for entering certain parameters from which the numerical risk characterization data can be obtained. One embodiment of such a data entry form is provided in FIGS. 3A through 3E.

Referring to FIG. 3A, in a header portion 300, general information identifying and characterizing the insurable entity are entered in various fields, including industry classification (SIC) and identifiers used by certain business data suppliers for the insurable entity, along with certain basic financial information concerning the insurable entity. The entity-specific information throughout FIGS. 3A through 3E is fictitious, and the named entity, DNA-R-US, is non-existent and is not intended to refer to any existing business. Program information is also entered in the header portion, including whether the insurable entity has been involved in a securities class action in the preceding twelve months and the date of the action, along with information concerning its D&O insurance coverage, including its deductible (SEC retention), premium and the identification of its carrier, as well as the limits of its policy.

In a question box 310, a user enters a numerical grade for overall corporate governance from 0 to 4 as one kind of numerical risk characterization data. The entered numerical grade corresponds to a corporate governance grade assessed by an independent rating service such as Board Analyst provided by The Corporate Library, LLC, Portland, Me., or the Corporate Governance Quotient provided by Institutional Shareholder Services, Inc., Rockville, Md. Question box 310 is also provided with a comments field, as are all other question boxes in FIGS. 3A through 3E for entering comments relevant to the numerical risk characterization data entered in the respective question box.

As also indicated in question box 310, a weight is assigned to the entered numerical grade, in this instance and embodiment, a weight of 0.17. This weight is determined based on a preexisting database of such numerical grades for a large number of publicly held companies by correlating such numerical grades for corporate governance with data indicating whether the corresponding companies had experienced a class action lawsuit in the previous twelve months alleging director or officer liability. All of the weights applied to the numerical risk characterization data throughout this embodiment are determined in the same manner. A method and system for producing the weights from such a database is described hereinbelow.

In question boxes 320 and 330, numerical risk characterization data are entered reflecting dependence on suppliers, products and customers, and are weighted according to the respective weights indicated. In question box 340 of FIG. 3A and question boxes 350 through 380, numerical risk characterization data concerning certain financial risk parameters are entered and weighted according to the respective weights indicated In question boxes 390 through 420, numerical risk characterizations of various parameters relating to management and shareholders are entered, and weighted as indicated in the respective question boxes.

In question box 430 of FIG. 3C, data is entered relating to investigations of the insurable entity, for example, by the US Securities and Exchange Commission, and to letters and inquiries therefrom. Because of a relatively high correlation of such data to the occurrence of shareholder class actions, this data is weighted relatively heavily. In question box 440, data is entered to numerically characterize the number of analysts who follow the insurable entity and is weighted accordingly. Question box 450 of FIG. 3D captures numerical risk characterization data concerning guidance provided by the insurable entity to the market for its equity securities, such as earnings reports and projections.

Question box 460 is used to enter numerical risk characterization data relating to compliance or non-compliance with securities exchange listing requirements. Question box 470 calls for numerical risk characterization data concerning stock drops in the preceding twelve months, which strongly correlates with the risk of a class action suit, as indicated by the relatively high weight accorded to this parameter. Question box 480 captures numerical risk characterization data corresponding to various types of insider stock sales and related conditions affecting the risk of a class action suit. Question box 490 enters numerical risk characterization data corresponding to levels of float adjusted market capitalization of the insurable entity's equity securities.

Question box 500 enables the entry of numerical risk characterization data that is particularly relevant to pharmaceutical and biotech companies, such as the fictitious entity, DNA-R-US, representing its current involvement in clinical trials. In the embodiment of FIGS. 3A through 3E, this weight is determined based on the numerical grades for all companies in the database by correlating such numerical grades for involvement in clinical trials with data indicating whether the corresponding companies had experienced a class action lawsuit in the previous twelve months alleging director or officer liability. In the embodiment of FIGS. 3a through 3E, there is a strong correlation between plans for clinical trials, and the existence and status of clinical trials, and the risk of a shareholders' class action suit, and so, this score is accorded a correspondingly high weight.

FIG. 3F is a table representing a further embodiment of a system similar to that of FIGS. 1 through 3E for producing reports concerning an insurable entity's susceptibility to an insurable claim, such as a claim by way of a shareholders' class action asserting liability of the insurable entity's directors and/or officers. In the embodiment of FIG. 3F, the elements are the same as in the embodiment of FIGS. 1 through 3E, except that a different preexisting database is used to derive the weights given to the numerical risk characterization data and the weight accorded to the numerical risk characterization data entered in question box 20 is determined in a different fashion as described hereinbelow. In particular, the database from which the weights are produced in the embodiment of FIG. 3F contain a relatively larger number of entities that that used to produce the weights used in the embodiment of FIGS. 1 through 3E.

Moreover, the form of the questionnaire used in the embodiment of FIG. 3F is the same as that of FIGS. 3A through 3E, except that the weights (as well as their ranks relative to each other) differ. Therefore, FIG. 3F only lists the weights as produced with the use of the relatively larger database of entities mentioned hereinabove and the ranks of such weights relative to each other.

In the embodiment of FIG. 3F, the weight accorded to the numerical risk characterization data entered by means of question box 20 of the questionnaire is produced using only the data for pharmaceutical and biotech entities in the relatively larger database of the FIG. 3F embodiment, rather than the data for all entities in the database, as in the embodiment of FIGS. 1 through 3E. As in the embodiment of FIGS. 1 through 3E, the weight given to the numerical risk characterization data concerning involvement in clinical trails entered by means of question box 20 of the questionnaire is produced by correlating such numerical grades for involvement in clinical trials for all pharmaceutical and biotech companies in the relatively larger database of this embodiment with data indicating whether the corresponding companies had experienced a class action lawsuit in the previous twelve months alleging director or officer liability.

In both of the above-described embodiments, and with reference again to FIG. 2, once the numerical risk characterization data has been entered as described above, processor 110 multiplies each by its respective weight (210 in FIG. 2) and sums all of the weighted data (220 in FIG. 2) to produce a risk score or numerical claim susceptibility risk value data. In the example of FIGS. 3A through 3E, the fictional insurable entity, DNA-R-US, is shown to have a risk score of 6.64.

Then, in response to a command entered by the user through input 140 or under the control of a stored instruction retrieved from storage 130, processor 110 controls the presentation device 150 to produce presentation data to the user comprising a report of the insurable entity's risk score. In the alternative, processor 110 stores the risk score in storage 130 to be presented to a user subsequently, either by presentation device 150 or by means of a different system in communication with system 100 via communications 120.

An example of such a report or presentation data produced by the embodiment of FIGS. 1 through 3E is provided by FIG. 4A for the fictitious entity DNA-R-US. At 590, the report presents the risk score or company risk susceptibility quotient (CRSQ) for this entity, 6.64 in this example, together with the ranking of this score against (1) the scores of all entities in the system's database that have had securities class action suits brought against them in the preceding year, and (2) the scores of all entities in the database that have not had such lawsuits brought against them in such year. In the report of FIG. 4A, the score of DNA-R-US is compared against scores of all entities in the database throughout all industries. The report of FIG. 4A also provides a graphical representation of the scores of all such entities distributed by percentile ranking (1) as curve 620, for all entities in the database that have had securities class action suits brought against them in the preceding year, and (2) as curve 610, for all entities in the database that have not had such lawsuits brought against them in such year. For the user's reference, the report of FIG. 4A provides a table 620 including average and quartile scores for entities that have had such suits, and separately for those that have not. The report also includes a table 630 of score ranges against susceptibility to a securities class action by score range.

A further example of such a report or presentation data produced by the embodiment of FIGS. 1 through 3E is provided by FIG. 4B for the fictitious entity DNA-R-US, in which its risk score is compared to those of entities only in its industry, the pharmaceutical and biotech industry. Similarly to the report of FIG. 4A, the report of FIG. 4B presents the risk score for DNA-R-US at 590, and provides a graphical representation of the scores of all entities in the database within the pharmaceutical and biotech industry distributed by percentile ranking (1) as curve 600, for all such entities that have had securities class action suits brought against them in the preceding year, and (2) as curve 610, for all such entities that have not had such lawsuits brought against them in such year. FIG. 4B provides a table 640 including average and quartile scores for entities within the pharmaceutical and biotech industry that have had such suits, and separately for those that have not.

In a modification of the reports of FIGS. 4A and 4B, the areas under the curves 600 and 610 are colored or shaded to distinguish those areas under the curves which represent a relatively low risk of a securities class action suit from those representing relatively higher risk and to distinguish the latter from those areas representing the highest risk. In certain embodiments, such low risk areas are depicted as shades of green which gradually transform to areas of relatively higher risk shaded in yellow. From the latter the areas gradually transform to reddish shading representing areas of highest risk. Reports of the kind illustrated in FIGS. 4A and 4B may also be produced using the embodiment of FIG. 3F in the same manner.

In certain embodiments, the system 100 produces presentation data in the form of a report for an insurable entity comparing its risk evaluation data for a securities class action or risk score, with risk scores for the same type of claim for other entities and parameters of insurance policies of such other entities covering such types of claims. An example of this type of report is provided in FIG. 5, in which a table is arranged to list entities having similar risk scores for securities class action suits and the parameters of their D&O insurance policies. Such policy parameters are obtained by surveying numerous insurable entities, for example, by means of the form of FIGS. 3A through 3E or of FIG. 3F, including the policy parameters in the header portion 300 of FIG. 3A. In the example of FIG. 5, the name of the entity for which the report has been prepared, the fictitious entity DNA-R-US, is included in an Entity column of the table in a second row thereof, while numerical identifiers for other entities in the database are included in respective rows below the second row. For each entity in the table, its risk score is included in the same row as the entity name in the second or Risk Score column, and various ones of its D&O insurance parameters are set out in the same row in respective columns for the name of its D&O insurance carrier, headed: Carrier; the SEC retention of its D&O policy, headed: SEC Retention; its annual D&O policy premium, headed: Premium; the traditional limit of its policy, headed: Limits-Traditional; the A side limit of its policy, headed: Limits-A Side; and the DIC (Differences in Conditions) limit of its policy, headed: Limits-DIC. The names of the insurance carriers in FIG. 5 are fictitious, are included only for purposes of illustration and are not intended to refer to any existing insurance company. Other forms of reports for comparing entity risk scores and policy parameters may also be employed. For example, instead of, or in addition to, listing scores and policy parameters for individual entities within the database, a range of comparable scores may be selected to produce average, median, quartile or other kinds of policy parameters for inclusion in the report. Also, policy parameters may be presented graphically as they vary from risk score to risk score. It will be appreciated that the universe of entities used to produce the report may consist of all entities in the database or a proper subset thereof, such as those within the same industry as the entity for which the report is produced.

It will be appreciated that other data presentation forms may be employed in place of, or in addition to, those described above in connection with FIGS. 4A, 4B and 5, such as bar charts, vertical bars or quartile charts, simple numerical, tabular form, a vertical scale (like a thermometer), scatter plots, color coding, graphical coding, or the like.

In certain embodiments, the system 100 is employed to produce or update the database of insurable entities that is used to produce risk scores, and produce reports of the kind described hereinabove. Such data is obtained from a form of the kind illustrated in FIGS. 3A through 3E of in FIG. 3F, from public company filings (for example, with the US Securities and Exchange Commission) and/or from other publicly or privately available databases. System 100 receives such data in processor 110 either via its input 140 or its communications 120. Risk correlatable data including the data called for in questions 310 through 500 of FIGS. 3A-3E or of FIG. 3F is stored by processor 110 in storage 130 in association with the name and other identifying data of the respective entity as well as its D&O policy parameters, and data indicating whether a securities class action lawsuit was commenced against the entity within the previous year.

An exemplary process for producing a weight for a selected parameter i is implemented by processor 110 running an Excel® spreadsheet application. FIG. 6 illustrates a portion of an Excel® spreadsheet, presented to a user by presentation device 150 under the control of processor 110 in which each entity in the database is identified by a unique index in a respective cell in a first column of the spreadsheet. In a second column of the spreadsheet, the risk correlatable parameter value for each entity is included in its corresponding row. Where, for example, the form of FIGS. 3A-3E or of FIG. 3F was used to enter this data, the risk correlatable parameter value corresponds to the numerical answer to a respective question in the form of FIGS. 3A-3E or of FIG. 3F used to gather such parameter value for the corresponding entity. In a third column of the spreadsheet, a “1” is entered if a securities class action lawsuit was commenced against the entity identified in the same row during the previous year. If not, a “0” is entered in the cell of the third column corresponding to the entity identified by its index in the first column. The processor 110 is programmed to perform a correlation of the data in the second and third columns using the Excel® CORREL function to produce a correlation coefficient which is then stored in storage 130 by processor 110 in association with risk correlatable descriptor category identification data identifying the corresponding risk parameter.

In certain embodiments, the correlation process is carried out by a different application. In certain embodiments, the database of weights is updated when a report is run supplying a risk score for an entity, while in others it is updated at a different time.

FIG. 7 illustrates additional systems for producing reports and producing and updating databases as described hereinabove. A user system 1000 comprises a processor 1100 coupled with a presentation device 1200 to control the device 1200 to provide presentation data to a user of the system 1000. Processor 1100 is also coupled with an input 1300 enabling the user to input data to the system 1000. The user system 1000 communicates with a network 1400 via communications (not shown for purposes of simplicity and clarity). Network 1400 enables user system 1000 to communicate with a database server 1500 and a report server 1600.

In certain embodiments, one or more of the databases used to produce reports as described hereinabove are stored by database server 1500 and accessed by user system 1000 via network 1400. In certain embodiments, database server 1500 stores the database of weights used in preparing reports which user system 1000 accesses and updates as new data from various entities are entered in user system 1000 by a user.

In certain embodiments, user system 1000 communicates a request for a report from report server 1600. For example, a user may employ user system 1000 to enter the appropriate data in the form of FIGS. 3A-3E which user system 1000 communicates to report server 1600. Report server 1600 responds by providing a requested report to user system 1000 based on the received data. In the alternative, user system 1000 can be employed by the user to request a report from report server 1600 based on data previously received thereby.

Although various embodiments of the present invention have been described with reference to a particular arrangement of systems, devices, methods, features, functions and the like, these are not intended to exhaust all possible arrangements and implementations, and indeed many other embodiments, modifications and variations will be ascertainable to those of skill in the art.

What is claimed is:

1. A method of producing a report for an insurable entity providing an evaluation of the insurable entity's susceptibility to an insurable claim of a kind occurring infrequently comprises: providing a plurality of numerical risk characterization data, each of the plurality of numerical risk characterization data corresponding to a respective one of a plurality of risk parameters relating to the insurable entity that is correlated to a susceptibility of the insurable entity to an insurable claim of a kind occurring infrequently; producing numerical claim susceptibility risk value data for the insurable entity based on the plurality of numerical risk characterization data; and providing presentation data to a user comprising a comparison of the numerical claim susceptibility risk value data of the insurable entity to numerical claim susceptibility risk value data of a plurality of other insurable entities.

2. The method of claim 1, wherein the numerical claim risk susceptibility value data is produced by applying a weighting factor to each of the plurality of numerical risk characterization data to produce a plurality of weighted numerical risk characterization data; and combining the plurality of weighted numerical risk characterization data to produce the numerical claim susceptibility value data for the insurable entity.

3. A system for producing a report to an insurable entity providing an evaluation of the insurable entity's susceptibility to an insurable claim of a kind occurring infrequently comprises a data providing device operative to provide a plurality of numerical risk characterization data, each of the plurality of numerical risk characterization data corresponding to a respective one of a plurality of risk parameters relating to the insurable entity that is correlated to a susceptibility of the insurable entity to an insurable claim of a kind occurring infrequently; a processor coupled with the data providing device to receive the numerical risk characterization data and operative to produce numerical claim susceptibility risk value data for the insurable entity based on the plurality of numerical risk characterization data; and a presentation device coupled with the processor to receive the numerical claim susceptibility risk value data and operative to provide presentation data to a user comprising a comparison of the numerical claim susceptibility risk value data of the insurable entity to numerical claim susceptibility risk value data of a plurality of other insurable entities.

4. The system of claim 3, wherein the processor is operative to produce the numerical claim risk susceptibility value data by applying a weighting factor to each of the plurality of numerical risk characterization data to produce a plurality of weighted numerical risk characterization data; and combining the plurality of weighted numerical risk characterization data to produce the numerical claim susceptibility value data for the insurable entity.

5. A method of producing a database for producing a report to an insurable entity providing an evaluation of the insurable entity's susceptibility to an insurable claim of a kind occurring infrequently, comprises providing a system comprising a processor, a data storage, and a data providing device; receiving or accessing risk correlatable data for a plurality of entities in the system using the data providing device, the risk correlatable data comprising a plurality of entity descriptors for each of the entities for each of a plurality of risk correlatable descriptor categories; receiving or accessing claims data for the plurality of entities in the system using the data providing device, the claims data indicating for each of the entities whether it has experienced an insurable claim of a kind occurring infrequently; storing the risk correlatable data and the claims data in the data storage; correlating the risk correlatable data and the claims data using the processor to produce weighting factor data for each of the risk correlatable descriptor categories; and producing the database by storing the weighting factor data and associated risk correlatable descriptor category identification data in the data storage.

6. A system for producing a database for producing a report to an insurable entity providing an evaluation of the insurable entity's susceptibility to an insurable claim of a kind occurring infrequently, comprises a data providing device, a processor coupled with the data providing device, and a data storage coupled with the processor; the processor being operative to receive risk correlatable data for a plurality of entities to the system from the data providing device, the risk correlatable data comprising a plurality of entity descriptors for each of the entities for each of a plurality of risk correlatable descriptor categories, as well as claims data from the data providing device for the plurality of entities, the claims data indicating for each of the entities whether it has experienced an insurable claim of a kind occurring infrequently; the processor being operative to store the risk correlatable data and the claims data in the data storage, to correlate the risk correlatable data and the claims data using the processor to produce weighting data for each of the risk correlatable descriptor categories, and produce the database by storing the weighting data and associated risk correlatable descriptor category identification data in the data storage.

7. A method of producing a report for an insurable entity comparing risk evaluation data for a predetermined type of insurable claim with data representing risk evaluations for the same predetermined type of insurable claim for other entities and parameters of insurance policies of such other entities covering such predetermined type of insurable claim, comprises producing risk evaluation data for an insurable entity comprising a value representing a measure of the insurable entity's risk for a predetermined type of insurable claim, providing a plurality of risk evaluation data for a plurality of other entities comprising values representing measures of such other entities' risks for such predetermined type of insurable claim, providing insurance data comprising parameters of insurance policies of such other entities covering such predetermined type of insurable claim, comparing the risk evaluation data of the insurable entity with the plurality of risk evaluation data for the plurality of other entities to produce comparison data, and producing presentation data comprising at least one insurance policy parameter for such predetermined type of insurable claim based on the comparison data and the parameters of insurance policies of such other entities.

8. A system for producing a report for an insurable entity comparing risk evaluation data for a predetermined type of insurable claim with data representing risk evaluations for the same predetermined type of insurable claim for other entities and parameters of insurance policies of such other entities covering such predetermined type of insurable claim, comprises a data providing device, a processor coupled with the data providing device, and a data storage coupled with the processor; the processor being operative to produce risk evaluation data for an insurable entity comprising a value representing a measure of the insurable entity's risk for a predetermined type of insurable claim, the processor being operative to receive from the data providing device a plurality of risk evaluation data for a plurality of other entities comprising values representing measures of such other entities' risks for such predetermined type of insurable claim and insurance data comprising parameters of insurance policies of such other entities covering such predetermined type of insurable claim, the processor being operative to compare the risk evaluation data of the insurable entity with the plurality of risk evaluation data for the plurality of other entities to produce comparison data, and to control the presentation device to produce presentation data comprising at least one insurance policy parameter for such predetermined type of insurable claim based on the comparison data and the parameters of insurance policies of such other entities.
